(19) United States
(12) Patent Application Publication
(10) Pub. No.: US 2025/0147180 A1
(43) Pub. Date: May 8, 2025

(54) LIGHT DETECTION AND RANGING (LIDAR) BASED NETWORK DESIGN AND OPTIMIZATION

(71) Applicant: T-MOBILE INNOVATIONS LLC., Overland Park, KS (US)

(72) Inventors: Bhagwan Singh KHANKA, Las Vegas, NV (US); Paul Henrich Antonio GABRIEL, Las Vegas, NV (US)

(21) Appl. No.: 18/504,315

(22) Filed: Nov. 8, 2023

(51) Int. Cl. G01S 17/08; H04W 24/02; H04W 24/10

(52) U.S. Cl. CPC G01S 17/08; H04W 24/02; H04W 24/10

(57) ABSTRACT

Methods and systems for LIDAR-based network design and optimization are provided. A network operator monitors signal quality from each access point antenna and collects signal quality metrics. LIDAR may be used to measure a distance to the obstruction. Based on the monitoring of the at least one signal quality metric from an access point antenna, the network operator may determine that the access point antenna signal may be blocked, completely or partially by an obstruction. The network may then direct a LIDAR module located at the base of the access point antenna to measure a distance from the access point to the obstruction. Based on the LIDAR measurements, at least one antenna operating parameter of the access point antenna is then adjusted. The at least one antenna operating parameter may be an azimuth setting, a tile angle, and an antenna power setting.

### BACKGROUND

Wireless networks are designed and optimized based on key performance indicators, knowledge of areas where access nodes are placed, and simulations of network performance. The result is a model of how the network will perform at each access node. As access points are placed in service areas, nearby obstructions can continue to change and develop. For example, new tall buildings can be erected, landscaping grows to significant heights, and new subdivisions can be built. All of these changes can result in the access point not performing as expected or not meeting key performance indicators. High resolution data could be used to adjust antenna azimuth, tilt, and power, however this data is expensive and difficult to obtain. Current network optimization solutions are time consuming and expensive to implement and may need to be repeated often as an access point site location changes in character and development.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for LIDAR based network design and optimization are provided. A network operator may monitor signal quality from each access point antenna and may collect signal quality metrics as part of the monitoring. Signal quality may be adversely affected when an obstruction blocks access point antenna signals. LIDAR may be used to measure a distance to the obstruction, which may be a building, tower, billboard, tree or plant. Based on the monitoring of the at least one signal quality metric from an access point antenna, the network operator may determine that the access point antenna signal may be blocked, completely or partially by an obstruction. The network may then direct a LIDAR module located at the base of the access point antenna to measure a distance from the access point to the obstruction. Based on the LIDAR measurements, at least one antenna operating parameter of the access point antenna is then adjusted. The at least one antenna operating parameter may be an azimuth setting, a tile angle, and an antenna power setting.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 depicts a diagram of a deployment of a LIDAR based network design and optimization system, in accordance with aspects herein;

FIG. 4 depicts a block diagram of a LIDAR based network design and optimization system, in accordance with aspects herein;

FIG. 5 depicts a flow diagram of an exemplary method for LIDAR based network design and optimization, in a network, in accordance with aspects herein; and

FIG. 6 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure.

Further, various technical terms are used throughout this description. An illustrative resource that fleshes out various aspects of these terms can be found in Newton's Telecom Dictionary, 32^{nd} Edition (2022).

Aspects disclosed herein provide a system and method for LIDAR based network design and optimization. Aspects disclosed herein provide methods and systems for incorporating the data captured by a LIDAR module positioned on the base of an antenna at an access point. The LIDAR module is used to capture obstructions that may have arisen since the installation of the access point. The data captured by the LIDAR module can be used in a self-optimizing network (SON) module to update antenna characteristics such as azimuth, tilt, power, and adjusting to operate with obstructions. The data captured during the LIDAR module operation may be stored at a network database. Optimizing an access point antenna may be performed on a scheduled basis or may be performed as needed, such as when antenna performance data shows degradation in antenna signal metrics and declines in key performance indicators. Predetermined thresholds for the antenna signal metrics and key performance indicators may be used to trigger LIDAR based network optimization.

New access points may also benefit from LIDAR based network design and optimization. Before an access point is built and operational a drone may be used to survey the site and obtain a three dimensional picture of the access point site and the surrounding area. A SON module may be used to input the LIDAR image and can be used to optimize antenna performance as the new access point is being constructed. The SON module may incorporate artificial intelligence. A new access point may be constructed to include a LIDAR module at the base of the antenna.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of access points (i.e., access point, node, cell sites, cell towers) to provide network coverage. The access points are employed to broadcast and transmit transmissions to user devices of the telecommunications network. An access point may be considered to be a portion of an access point that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, an access point may comprise one access point or more than one access point. Factors that can affect the telecommunications transmission include, e.g., location and size of the access points, and frequency of the transmission, among other factors. The access points are employed to broadcast and transmit transmissions to user devices of the telecommunications network. Traditionally, the access point establishes uplink (or downlink) transmission with a mobile handset over a single frequency that is exclusive to that particular uplink connection (e.g., an LTE connection with an EnodeB). The access point may include one or more sectors served by individual transmitting/receiving components associated with the access point (e.g., antenna arrays controlled by an EnodeB). These transmitting/receiving components together form a multi-sector broadcast arc for communication with mobile handsets linked to the access point.

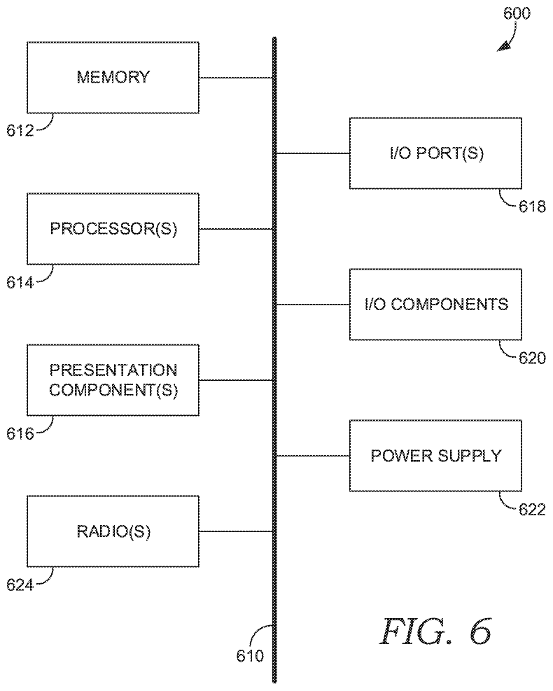

As used herein, “access point” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE). The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby access point. A UE may be, in an embodiment, similar to computing device 600 described herein with respect to FIG. 6.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby access point or access point.

A first aspect of the present disclosure provides a method for LIDAR based network design and optimization. The method begins with monitoring at least one antenna signal quality metric of an access point antenna. Then, based on the monitoring, the method continues with determining that an obstruction is in a path of the access point antenna. Then, using LIDAR, a distance from the access point antenna to the obstruction is measured. The method concludes with adjusting the at least one antenna operating parameter of the access point antenna based on the distance from the access point antenna to the obstruction.

A second aspect of the present disclosure provide a further method for LIDAR based network design and optimization. The method begins with the access point antenna transmitting an antenna signal report to a network. The access point antenna then receives from the network, a measurement request based on the antenna signal report. The measurement request causes a LIDAR module to measure a distance to at least one obstruction near the access point antenna.

Another aspect of the present disclosure is directed to a non-transitory computer storage media storing computer-usable instructions that cause the processors to monitor at least one antenna signal quality metric of an access point antenna. The instructions then determine that an obstruction is in a path of the access point antenna, based on the monitoring. The processors then instruct a LIDAR module to measure a distance from the access point antenna to the obstruction. Based on the distance from the access point to the obstruction, the processors then instruct the adjustment of at least one antenna operating parameter of the access point antenna.

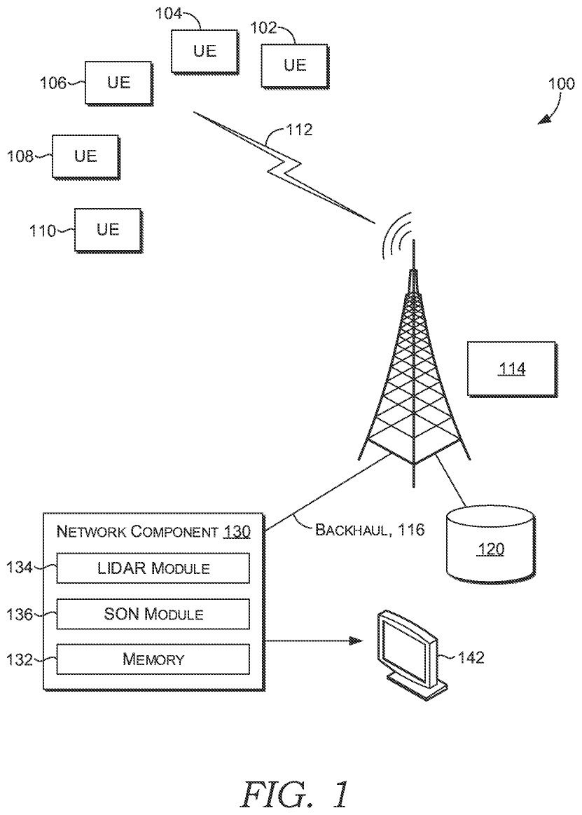

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

Network environment 100 includes user devices (UE) 102, 104, 106, 108, and 110, access point 114 (which may be a cell site, access point, or the like), and one or more communication channels 112. The communication channels 112 can communicate over frequency bands assigned to the carrier. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 600) that communicates via wireless communications with the access point 114 in order to interact with a public or private network. A UE may also be a wearable device such as a smart watch, smart glasses, fitness tracker or similar device.

In some aspects, each of the UEs 102, 104, 106, 108, and 110 may correspond to computing device 600 in FIG. 6. Thus, a UE can include, for example, a display(s), a power source(s) (e.g., a battery), a data store(s), a speaker(s), memory, a buffer(s), a radio(s) and the like. In some implementations, for example, a UEs 102, 104, 106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, 6G, LTE, CDMA, or any other type of network. In some cases, UEs 102, 104, 106, 108, and 110 in network environment 100 can optionally utilize one or more communication channels 112 to communicate with other computing devices (e.g., a mobile device(s), a server(s), a personal computer(s), etc.) through access point 114.

The network environment 100 may be comprised of a telecommunications network(s), or a portion thereof. A telecommunications network might include an array of devices or components (e.g., one or more access points), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure. Network environment 100 may comprise equipment placed in network operator facilities, but may also comprise equipment located at a customer's premises, known as customer premises equipment (CPE).

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, 6G, and the like) to user devices, such as UEs 102, 104, 106, 108, and 110. For example, the one or more communication channels may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1x circuit voice, a 3G network (e.g., CDMA, CDMA2000, WCDMA, GSM, UMTS), a 4G network (WiMAX, LTE, HSDPA), or a 5G network or a 6G network. The telecommunication network may also provide services using MU-MIMO techniques.

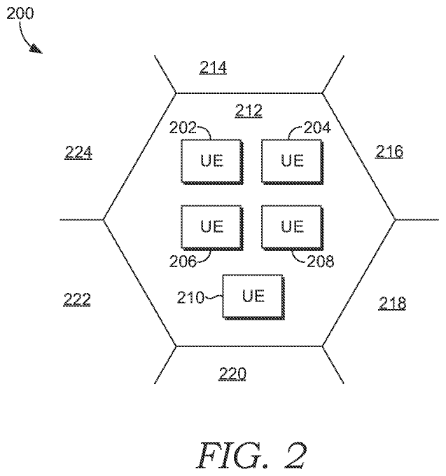

In some implementations, access point 114 is configured to communicate with a UE, such as UEs 102, 104, 106, 108, and 110, that are located within the geographic area, or cell, covered by radio antennas of access point 114. FIG. 2, below, illustrates multiple cells in a network. Access point 114 may include one or more access points, base transmitter stations, radios, antennas, antenna arrays, power amplifiers, transmitters/receivers, digital signal processors, control electronics, GPS equipment, sensors and sensor arrays and the like.

As shown, access point 114 is in communication with a network component 130 and at least a network database 120 via a backhaul channel 116. As the UEs 102, 104, 106, 108, and 110 collect individual signal information, the signal information can be automatically communicated by each of the UEs 102, 104, 106, 108, and 110 to the access point 114. Access point 114 may store the signal information and data communicated by the UEs 102, 104, 106, 108, and 110 at a network database 120. The network database 120 may also store antenna signal metrics and key performance indicators for each access point in the network. Alternatively, the access point 114 may automatically retrieve the status data from the UEs 102, 104, 106, 108, and 110, and similarly store the data in the network database 120. The signal information and data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data and antenna signal metrics and key performance indicators stored in the network database 120 current. For example, the data may be received at or retrieved by the access point 114 every 10 minutes and the data stored at the network database 120 may be kept current for 30 days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like. The network database 120 may also store information on LIDAR based optimizations of the access point antenna, including how long it has been since the access point has been assessed.

The network component 130 comprises a memory 132, a LIDAR module 134, and a SON module 136. All determinations, calculations, and data further generated by the LIDAR module 134 and the SON module 136 may be stored at the memory 132 and also at the network database 120. Computer terminal 142 is in communication with the network component 130 and with the memory 132, LIDAR module 134, and SON module 136 through the network component 130. Although the network component 130 is shown as a single component comprising the memory 132, LIDAR module 134, and SON module 136, it is also contemplated that each of the memory 132, LIDAR module 134, and SON module 136 may reside at different locations, be its own separate entity, and the like, within the home network carrier system.

The network component 130 is configured to receive data from the LIDAR module 134 from the access point 114 or one of the UEs, 102, 104, 106, 108, and 110. The LIDAR module 134 may be located at the base of an antenna on the access point 114 or may be located nearby on a building, pole, or other structure. The SON module 136 may be located in a central office or other centralized location, but may also be mounted on the access point 114. The LIDAR module 134 acts to measure distances between the access point 114 and obstructions. The LIDAR module 134 may act in conjunction with and as directed by the SON module 136 to perform network optimization by re-measuring distances to known obstructions and mapping locations of new obstructions. The SON module 136 may incorporate AI to automatically activate the LIDAR module 134 on the basis of degradation of antenna performance and/or a decline in network key performance indicators.

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cell sites 212, 214, 216, 218, 220, 222, 224,, each including access point 114, backhaul channel 116, antenna for sending and receiving signals over communication channels 112, network database 120 and network component 130. The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and WiFi router 210, may be located within geographic area 200 collecting UE data that is useable by network component 130, in accordance with aspects herein. UEs 202, 204, 206, 208, and WiFi router 210 can move within the cell currently occupying, such as cell site 212 and can move to other cells such as adjoining cell sites 214, 216, 218, 220, 222 and 224.

LIDAR is a remote sensing method that measures variable distances, or ranges, using pulsed lasers. An object is targeted with the pulsed laser and the time taken by the reflected light to return to the receiver is measured. In addition, LIDAR can operate in a fixed direction or may be operated in multiple directions. The LIDAR module 134 may be used in multiple directions at access point sites that are undergoing significant construction or change or may be used in a single fixed direction at other access point sites. LIDAR can be used to measure distances and can also be used for mapping and three dimensional representations of the Earth's surface.

The LIDAR module 134 can be used in conjunction with the SON module 136. A SON provides automation technology that simplifies and facilitates network planning, coordination, management, and healing. In addition, a SON can automatically link different wireless networking devices together, using mesh networking. A SON can be used to improve network coverage and enhance security. The SON module 136 in the network component 130 provides network optimization services in conjunction with the LIDAR module 134.

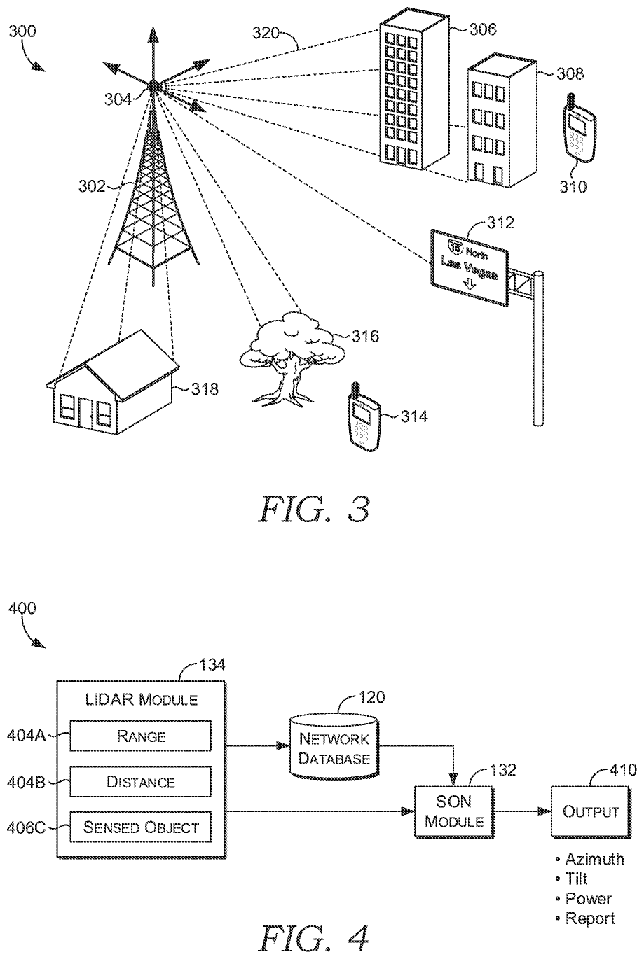

FIG. 3 depicts a diagram of a deployment of a LIDAR based network design and optimization system, in accordance with aspects herein. The system 300 includes an access point 302 with a LIDAR module 304 mounted at the base on the antenna. The LIDAR module 304 transmits LIDAR signals 320 within a coverage area of the access point 302. The LIDAR signals 320 may be reflected back by tall buildings such as building 306 and building 308. User device 310 may be adversely affected by building 306 and building 308. Not only buildings but other physical objects cities, such as a road sign 312, may also cause disruption to user device 314 and may be reflected back to LIDAR module 304. Large trees, such as tree 316, may also be measured with the LIDAR module 304. The LIDAR signals 320 may also be reflected by house 318. The LIDAR module 304 mounted on access point 302 provide improved coverage and serve as the “eye” of the access point 302. The examples above (e.g., trees, road signs, buildings, houses, etc.) are described herein to provide clarity but are not intended to limit the scope of the invention as any physical object over a predetermined size may be disruptive.

Based on the information collected by the LIDAR module 304, the antenna of the access point may be adjusted. The adjustments may be made to the azimuth setting based on the immediate obstructions near the access point 302. Antenna tilt may also be calculated based on the LIDAR module 304 collected information. The range may be calculated to a point where the range optimally services the area after the obstruction test using LIDAR is completed. Additional LIDAR measurements may be used to enhance the access point 302 footprint. The LIDAR measurements may be repeated as new obstructions arise, which may consist of new buildings, tree growth, or billboards. Furthermore, the SON module 136 may be used to further optimize power management.

FIG. 4 depicts a block diagram of a LIDAR based network design and optimization system, in accordance with aspects herein. The LIDAR based network design and optimization system 400 includes LIDAR module 134. The LIDAR module 134 may be located within a network component 130 which may be mounted at the access point 302 or may be mounted at a network office. The LIDAR module 134 may include sub-modules for range 404A, distance 404B, and sensed object 406C. The sensed object 406C sub-module may contain information on the type of object sensed and prior LIDAR measurements.

Data from the LIDAR module 134 may be stored in the network database 120. The network database 120 may be in communication with SON module 136. SON module 136 may also be in communication with LIDAR module 134. In addition, SON module 136 may provide output 410. The output 410 may comprise azimuth adjustments, tilt adjustments, and power adjustments. The output 410 may further comprise a report on the results of the LIDAR measurements.

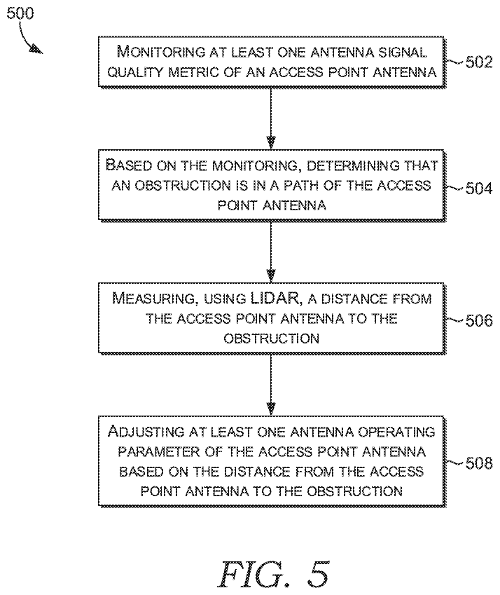

FIG. 5 depicts a flow diagram of an exemplary method for LIDAR based network design and optimization, in a network, in accordance with aspects herein. The method 500 begins with step 502 monitoring at least one antenna signal quality metric of an access point antenna. The method continues with step 504, based on the monitoring, determining that an obstruction is in a path of the access point antenna. Then, in step 506 the method proceeds with measuring, using LIDAR, a distance from the access point antenna to the obstruction. The method concludes in step 508 with adjusting at least one antenna operating parameter of the access point antenna based on the distance from the access point antenna to the obstruction.

The at least one antenna signal quality metric that is monitored may be at least one of: transmit power, signal to interference and noise ratio (SINR), signal strength, and signal to noise ratio. The antenna operating parameter that is adjusted may be at least one of an azimuth setting, a tilt angel, and an antenna power setting. The LIDAR based measurement may be repeated on a periodic basis. The periodic basis may be a predetermined interval of time or may be repeated if the access point antenna signal quality metric degrades below a predetermined threshold. The obstruction may change in height over time, for example, a tree or shrub may grow, and a new building may increase in height as construction continues. A billboard may be placed in the path the access point antenna, creating a new obstruction.

FIG. 6 depicts an exemplary computing device suitable for use in implementations of the present disclosure, in accordance with aspects herein. With continued reference to FIG. 6, computing device 600 includes bus 610 that directly or indirectly couples the following devices: memory 612, one or more processors 614, one or more presentation components 616, input/output (I/O) ports 618, I/O components 620, radio(s) 624, and power supply 622. Bus 610 represents what may be one or more busses (such as an address bus, data bus, or combination thereof). Although the devices of FIG. 6 are shown with lines for the sake of clarity, in reality, delineating various components is not so clear, and metaphorically, the lines would more accurately be grey and fuzzy. For example, one may consider a presentation component such as a display device to be one of I/O components 620. Also, processors, such as one or more processors 614, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer-storage media in the form of volatile and/or nonvolatile memory. Memory 612 may be removable, nonremovable, or a combination thereof. Exemplary memory includes solid-state memory, hard drives, optical-disc drives, etc. Computing device 600 includes one or more processors 606 that read data from various entities such as bus 610, memory 612 or I/O components 620. One or more presentation components 616 present data indications to a person or other device. Exemplary one or more presentation components 616 include a display device, speaker, printing component, vibrating component, etc. I/O ports 618 allow computing device 600 to be logically coupled to other devices including I/O components 620, some of which may be built into computing device 600. Illustrative I/O components 620 include a microphone, joystick, game pad, satellite dish, scanner, printer, wireless device, etc.

The radio(s) 624 represents one or more radios that facilitate communication with a wireless telecommunications network. While a single radio 624 is shown in FIG. 6, it is contemplated that there may be more than one radio 624 coupled to the bus 610. Illustrative wireless telecommunications technologies include CDMA, GPRS, TDMA, GSM, and the like. The radio 624 may additionally or alternatively facilitate other types of wireless communications including Wi-Fi, WiMAX, LTE, 3G, 4G, LTE, 5G, NR, VOLTE, or other VOIP communications. As can be appreciated, in various embodiments, radio 624 can be configured to support multiple technologies and/or multiple radios can be utilized to support multiple technologies. A wireless telecommunications network might include an array of devices, which are not shown so as to not obscure more relevant aspects of the invention. Components such as a access point, a communications tower, or even access points (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for light detection and ranging (LIDAR) based network optimization, the method comprising:
monitoring at least one antenna signal quality metric of an access point antenna;
based on the monitoring, determining that an obstruction is in a path of the access point antenna;
measuring, using LIDAR, a distance from the access point antenna to the obstruction; and
adjusting at least one antenna operating parameter of the access point antenna based on the distance from the access point antenna to the obstruction.

2. The method of claim 1, wherein the at least one antenna signal quality metric is at least one of: transmit power, signal to interference and noise ratio (SINR), signal strength, and signal to noise ratio.

3. The method of claim 1, wherein the at least one antenna operating parameter is at least one of: an azimuth setting, a tilt angle, and an antenna power setting.

4. The method of claim 1, further comprising repeating the LIDAR measuring on a periodic basis.

5. The method of claim 4, wherein the periodic basis is a predetermined interval of time.

6. The method of claim 4, wherein the periodic basis is based on degradation of the access point antenna signal quality metric below a predetermined threshold.

7. The method of claim 4, wherein the periodic basis is based on a change in height of the obstruction over time.

8. The method of claim 6, wherein the degradation of the access point antenna signal quality metric is caused by a new obstruction.

9. The method of claim 1, wherein the obstruction is at least one of: a building, a billboard, a tower, or natural growth.

10. A method for light detection and ranging (LIDAR) based network optimization, the method comprising:
transmitting, by an access point antenna, an antenna signal report to a network;
receiving, from the network, a measurement request based on the antenna signal report;
measuring, by a LIDAR module, a distance to at least one obstruction near the access point antenna in response to the measurement request; and
adjusting at least one antenna operating parameter of the access point antenna based on the distance from the access point antenna to the obstruction.

11. The method of claim 10, wherein the antenna signal report comprises at least one of: transmit power, signal to interference and noise ratio (SINR), signal strength, and signal to noise ratio.

12. The method of claim 10, further comprising receiving instructions from the network to adjust at least one antenna operating parameter.

13. The method of claim 12, wherein the at least one antenna operating parameter is at least one of: an azimuth setting, a tilt angle, and an antenna power setting.

14. The method of claim 11, wherein the sensor array comprises at least one of: an aural sensor, a visual sensor, and a vibration sensor.

15. A non-transitory computer storage media storing computer-usable instructions that, when used by one or more processors, cause the processor to:
monitor at least one antenna operating signal quality metric of an access point antenna;
based on the monitor, determine that an obstruction is in a path of the access point antenna;
measure, using light detection and ranging (LIDAR), a distance from the access point antenna to the obstruction; and
adjust at least one antenna operating parameter of the access point antenna based on the distance from the access point antenna to the obstruction.

16. The non-transitory computer storage media of claim 15, wherein the at least one antenna signal quality metric is at least one of: transmit power, signal to interference and noise ratio (SINR), signal strength, and signal to noise ratio.

17. The non-transitory computer storage media of claim 15, wherein the at least one antenna operating parameter is at least one of: an azimuth setting, a tilt angle, and an antenna power setting.

18. The non-transitory computer storage media of claim 15, further comprising repeat the LDIAR measurement on a periodic basis.

19. The non-transitory computer storage media of claim 18, wherein the periodic basis is a predetermined interval of time.

20. The non-transitory computer storage media of claim 18, wherein the periodic basis is based on degradation of the access point antenna signal below a predetermined threshold.
